(19) United States
(12) Patent Application Publication
(10) Pub. No.: US 2018/0067023 A1
(43) Pub. Date: Mar. 8, 2018

(54) METHOD AND APPARATUS FOR MANUFACTURING MEMBRANES BY PROCESSING THIN-FILM MATERIALS WITH A FLOW OF ELECTRICALLY CHARGED SOLID PARTICLES

(71) Applicant: POLYMATE, LTD, Migdal Ha'Emeq (IL)

(72) Inventors: Pavel Kudryavtsev, Bat Yam (IL); Oleg Figovsky, Haifa (IL)

(73) Assignee: NANOTECH INDUSTRIES, INC., Daly City, CA (US)

(21) Appl. No.: 15/256,657

(22) Filed: Sep. 5, 2016

(51) Int. Cl. G01N 3/04; G01N 3/56

(52) U.S. Cl. CPC G01N 3/04; G01N 3/56

(57) ABSTRACT

Proposed is a reliable and cost-effective universal material tester with reduced cross-talk between the sensors. The sensor unit consists of a pressure-sensor unit that measures a vertical force applied to the test probe during movement of the test probe relative to the test specimen and a horizontal force sensor unit for measuring the horizontally directed friction force. The horizontal force sensor unit is made in the form of a flexible parallelogram consisting of two sensor-holding plates interconnected through flexible beams, wherein one end of the first beam is attached to the upper sensor-holding plate and the opposite end to the lower sensor-holding plate, while one end of the second beam is attached to the lower sensor-holding plate and the other to the upper one. The beams are installed with gaps relative to both plates. The tester has a quick-release test probe that incorporates a soft-touch feature.

### BACKGROUND OF THE INVENTION

### Field of the Invention

The present invention relates to a method and apparatus for manufacturing membranes by processing thin-film materials with a flow of electrically charged solid particles. More specifically, the invention relates to a method and apparatus for manufacturing track membranes by piercing a matrix of a thin-film material with a flow of hard particles generated by an electric field.

### Description of the Related Art

Membrane technology is a rapidly developing field, which has many practical applications of great technological and ecological values. One well-known type of membrane is the track membrane. These membranes are sheets of different materials having a plurality of holes extending through the entire thickness of the membrane sheet. Such membranes are made from polymeric materials by uniformly bombarding matrix sheets with heavily charged particles (heavy ions) that possess high energy and form tracks of damage in the membrane material.

A method and apparatus for forming apertures in a solid body is described in U.S. Pat. No. 3,303,085 issued on Jan. 7, 1967 to Paul B. Price. The method consists of subjecting the solid body to the action of heavily charged particles that damage the mass of the solid body and then removing the damaged substances from the matrix material by chemical etching. If the solid body is a thin-film material, such as a mica sheet, it can be formed, e.g., into a molecular sieve having a plurality of straight-through apertures opening through the top and bottom, with opening diameters in the range of 5 to 20,000 Angstroms. The etching material and methods of etching suitable for the above processes are disclosed, e.g., in U.S. Pat. No. 3,770,532 issued to Bean, et al, on Nov. 6, 1973; U.S. Pat. No. 3,802,972 issued to Fleischer, et al, on Apr. 9, 1974; U.S. Pat. No. 7,001,501 issued to Spohr, et al, on Feb. 21, 2006; and U.S. Pat. No. 7,597,815 issued to Desyatov, et al, on Oct. 6, 2009.

However, membranes obtained by the method mentioned above are characterized by nonuniformity of opening diameters that may vary from 10 nm to 10 μm. Furthermore, the method of manufacturing membranes by bombarding a thin-film material with heavy ions is very expensive, labor-consuming, and requiring the use of bulky and very dangerous equipment.

On the other hand, at the present time there exists a need for inexpensive porous membranes obtainable in continuous mass production with the size of open pores ranging from 1 to 100 μm. Such membranes are widely used in medicine, for example, in the purification of drugs and vaccines, in obtaining blood plasma, and in bacteriological quality control of food and water. They are used for cleaning air and liquids, for example, in creating clean rooms, and in drinking water purification systems, as well as in systems of analytical control of substances.

Also known in the art are methods and apparatuses for treating various materials and articles, including membranes made of polymers, by using the energy of an air jet (see, e.g., U.S. Pat. No. 4,960,430 issued on Oct. 2, 1990 to Koerber, et al). The method disclosed in the above patent relates to treating a synthetic polymeric product in the form of a sheet, strand, or filament to render the surface thereof mat or rough, comprising impacting the surface at a temperature of 15° C. to the softening point of the polymer with 0.1 to 2 mm particles of sand, glass, corundum, or metal. The particles are carried by a jet of gas, e.g., air, and impacting is effected by directing a stream of gas-carrying particles onto the surface.

A method and apparatus for Impact implantation of particulate material into polymer surfaces is disclosed in U.S. Pat. No. 5,330,790 issued to Calkins in 1994. This method relates to treating the surface of a polymeric article by impact implantation with particulate material to attain hardening, abrasion resistance, or other altered surface characteristics. High-pressure treatment with a slurry of a liquid mixed with a ceramic particulate material in the 66 to 350-micron particle size range can be employed to implant the surface of a polymeric article to attain improved abrasion and erosion resistance. Similarly, impact implantation with electrically conductive or magnetic materials can be employed to attain a conductive surface or a surface having electromagnetic radiation absorption characteristics. In addition to water jet impact implantation, there are disclosed methods of ultrasonic, sheet explosive, and mechanical particle implantation.

Similarly, the surface treatment with implantation of electrically conductive or magnetic materials may be used for imparting to surfaces of the treated object electrically conductive or electromagnetic-radiation-absorptive properties.

Along with other methods, penetration of a particulate material may be caused by impact waves caused by an explosion that results from the use of explosive materials. Such a method is applicable for any commercially available plastics, including conventional thermoplasts, e.g., Nylon, polyam ides, poyesters, and polyolefins, such as polyethylene and polypropylene, as well as fluoroplasts, polyamides, polycarbonates, ABC-plastics, or thermoplastics, including reinforced and composite materials.

Ceramic macroparticles for implantation may comprise electro-corundum (Al₂O₃), boron-carbide (BC), silicone-carbide (SiC), titanium diboride (TiB₂), boron nitride (BN), quartz (SiO₂), garnet, zirconium, or mixtures thereof.

However, all methods described above are not suitable for the manufacture of track membranes because production of track membranes involves deep penetration of the particles into the membrane material or complete passage of the particles through the membrane matrix material.

A method and apparatus for deep penetration of particles into the matrix of a solid material is disclosed in U.S. Pat. No. 7,897,204 issued on Mar. 1, 2011 to S. Usherenko. The method is intended for strengthening a matrix of high-speed steel for forming a composite tool material by super-deep penetration of reinforcing particles into and through the matrix of the tool material. The particles interact with the matrix in the form of a high-speed jet generated and energized by explosion of an explosive material that contains premixed powdered components of the working medium composed of particles of a hard material and ductile metal, and, if necessary, with addition of a process liquid. The particles of the working medium material range from 1 to 100 μm in size. The jet has a pulsating nature with a velocity ranging from 200 to 600 m/sec and a temperature ranging from 100 to 2000° C. As a result of strengthening, the steel matrix is reinforced by elongated zones of the working material particles which are oriented in the direction of the jet and occupy less than 1 vol. % of the matrix material, while less than 10 vol. % is occupied by the zones of the matrix restructured as a result of interaction with the particles of the super-high-velocity jet.

The main drawback of this method is its very design, i.e., all the risks associated with the use of explosives. Moreover, employment of the explosive limits the size of the resultant membrane, while preparation of the material and the apparatus for the manufacturing process takes a long time. The method cannot provide uniformity in distribution of track holes and their diameters.

Another significant disadvantage of the explosion method is that it does not take into account a reflected wave during detonation. At the same time, the shock wave is reflected from the shell and moves to the center carrying with it a significant portion of energy, while the pressure around the shell rapidly falls off (faster than instantaneous detonation). As a result, acceleration of the shell is reduced more rapidly than with instantaneous detonation. Thus, only particles that reach the membrane effectively penetrate into the matrix material. This significantly reduces the efficiency of the explosive impact on the membrane matrix.

U.S. Pat. No. 8,980,148 issued on Mar. 17, 2015 to O. Figovsky, et al, discloses a method and apparatus for manufacturing track membranes by penetration of working substances into and through the membrane matrix of polymer material. The matrix is placed into a holder that is inserted into one end of a tubular shell, the other end of which contains a cartridge with an explosive material and a working substance in the form of a supersaturated solution of a water-soluble salt. When the explosive material is detonated, the particles of the water-soluble salt interact with the matrix in the form of a high-speed jet with the velocity of particles in the range of 3800 to 4200 m/sec. As a result of particle penetration into and through the material of the matrix, a plurality of holes is formed in the matrix. The track membranes are produced by slicing the membrane matrix after removal of the residue of the particles by washing the pierced membrane with water.

This method entails the same disadvantages as the method of U.S. Pat. No. 7,897,204 regarding nonuniformity in distribution of hole diameters and their arrangement.

### SUMMARY OF THE INVENTION

The present invention relates to a method and apparatus for treating thin-film materials with a flow of electrically chargeable solid particles in an electric field. More specifically, the invention relates to a method and apparatus for manufacturing track membranes by piercing a matrix of a thin-film material with a flow of hard particles generated by an electric field. The essence of the method consists of charging and accelerating particles of a powder that constitutes a working material for treating, e.g., perforating, a thin-film object intended for manufacturing, e.g., a track membrane that can be used for dialysis, filtering gases, etc. The particles are accelerated and acquire kinetic energy under the effect of an electric field developed between two metallic electrodes such as a continuous charging electrode and a perforated acceleration electrode, e.g., in the form of a net. The object being treated may comprise a replaceable thin-film sheet or a belt moved from a delivery bobbin to a receiving bobbin and exposed to the action of the particles that moves with high speed toward the treated object through the acceleration electrode.

The acceleration electrode is made in the form of a net with a plurality of openings or cells for passing the particles to the exposed object, while the charging electrode has a continuous surface. The use of the net provides uniformity in distribution of the openings formed in the treated thin-film material.

The method of the invention is carried out as follows.

First, a specific powder of a selected material, shape, and size is supplied to the inter-electrode space by means of the powder supply unit or injector. Next, constant voltage (CV) is supplied to the metallic electrodes. A part of the powder particles should already have an uncompensated charge, but neutral particles will acquire the uncompensated charge under the effect of the electric field. As a result, under the effect of the electric field (EF), which is generated between the electrodes in the interelectrode space, the charged particles begin to move with acceleration to the acceleration electrode and, when reaching this electrode, the particles develop significant kinetic energy that depends on the value of the charge, particle mass, and potential difference between electrodes.

### BRIEF DESCRIPTION OF THE DRAWINGS

FIG. 1 is a schematic vertical and sectional view of the apparatus of the present invention.

FIG. 2 is a graph that shows theoretical and experimental values of a critical electric field for various solid materials as a square root function of particle density and size; experimental data, shown by white dots, were obtained in experimental tests of the method of the present invention.

FIG. 3 is a graph that shows the effect of external pressure (P, atm) on the velocity of movement of aluminum oxide particles with an average size of 100 μm in the electric field generated by the 10000 V potential difference at the interelectrode distance of 10 mm; experimental data, which are shown by white dots, were obtained in experimental tests of the method of the present invention.

FIG. 4 is a graph that shows the effect of the potential difference on the velocity of aluminum oxide particles with an average size of 100 μm at the interelectrode distance of 10 mm and under pressure of 0.01 atm; experimental data, which are shown by white dots, were obtained in experimental tests of the method of the present invention.

FIG. 5 is a graph that shows the effect of the of aluminum oxide particle size on the velocity of its movement in an electric field generated by the 10000 V potential difference at the inter-electrode distance of 10 mm and under pressure of 0.01 atm.

FIG. 6 is a graph that shows the effect of the inter-electrode distance (l, m) on the velocity of movement of the aluminum oxide particles having an average size of 50 μm in an electric field generated by the 10000 V potential difference under pressure of 0.01 atm; experimental data, which are shown by white dots, were obtained in experimental tests of the method of the present invention.

FIG. 7 is a graph that shows the effect of the average size of the aluminum oxide particles on the value of the critical field at pressure 0.01 atm; experimental data, which are shown by white dots, were obtained in experimental tests of the method of the present invention.

FIG. 8 is a graph that shows the effect of the average size of aluminum oxide particles and voltage between the electrodes on the depth of penetration of the particles into the polyethylene matrix at pressure of 0.01 atm; experimental data, which are shown by white dots, were obtained in experimental tests of the method of the present invention.

FIG. 9 shows dependence of the theoretical depth of penetration of the aluminum oxide particles with a size of 150 μm into the polyethylene matrix on the voltage between the electrodes under pressure of 0.01 atm; the curve with round dots was plotted on the basis of experimental data; experimental data, which are shown by white dots, were obtained in experimental tests of the method of the present invention.

### DETAILED DESCRIPTION

The invention relates to a method and to apparatus for treating thin-film materials with a flow of electrically chargeable solid particles in an electric field. More specifically, the invention relates to a method for manufacturing a track membrane by piercing a matrix of a thin-film material with a flow of hard particles generated by an electric field. In particular, according to the invention, charging and acceleration of particles occur under the effect of the electric field.

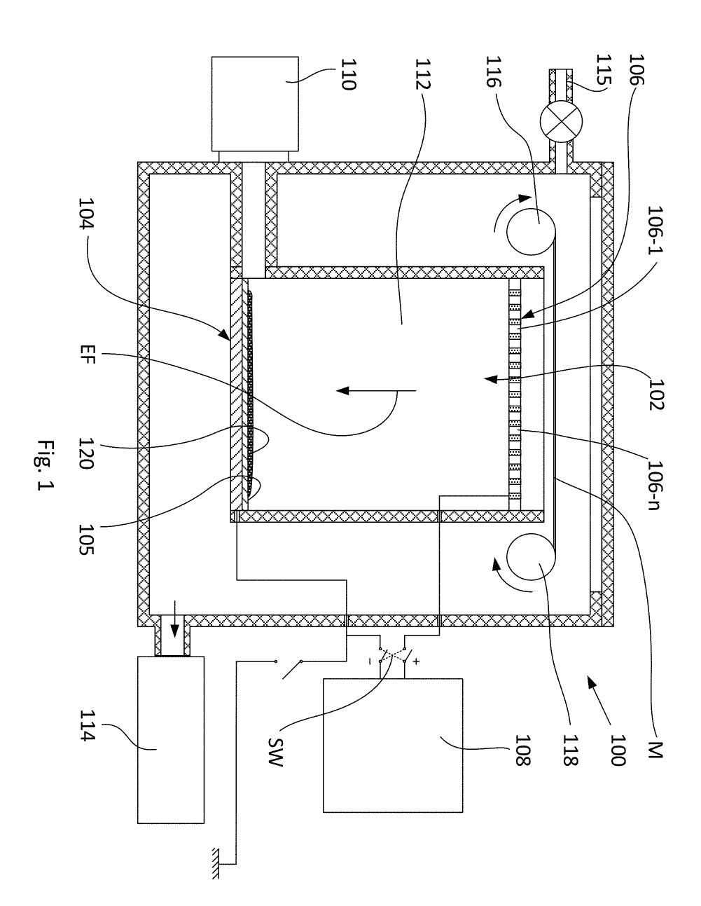

Realization of the method of the invention is based on use of an apparatus, which is schematically shown in FIG. 1 and is designated as a whole by reference numeral 100. The apparatus 100 consists of a closed chamber 102 that contains two mutually spaced and electrically separated metallic electrodes 104 and 106. One of the electrodes, i.e., electrode 106, which herein is called an acceleration electrode, has a plurality of openings 106-1, 106-2, 106-3, . . . 106-n, if this electrode is a net, while another electrode 104, which herein is referred to as a charging electrode, is continuous. If necessary, the facing surfaces of the metallic electrodes can be coated with dielectric coatings such as a coating 105 on the charging electrode 104 for isolation of the electrode metal from interaction with the powder material if this material is aggressive toward the metallic material of the electrodes. The facing surface of the acceleration electrode 106 also may be covered with a similar coating (except for the openings).

The apparatus 100 is also provided with an adjustable high-voltage power supply unit 108 for the supply of constant voltage (CV) to the electrodes and a powder supply unit or injector 110 for the supply of a specific powder into the interelectrode space 112 formed between the electrodes, preferably closer to the continuous electrode 104. The apparatus may be equipped with a vacuum pump 114 for evacuation of air from the interior of the interelectrode space 112 and with an inert gas injector 115 for injection of inert gas into the aforementioned space 112. A thin film material M, which in FIG. 1 is shown as a continuous belt moveable from the supply unit, e.g., supply bobbin 116 to the receiving unit, e.g., a receiving bobbin 118, is located over the acceleration electrode 106. A thin-film material is located over the net-like electrode and may comprise a thin-film material movable from a supply drum to a receiving drum.

The method is carried out as follows.

Realization of the method of the invention is based on the use of the apparatus of FIG. 1. First, a specific powder of a selected material, shape, and size is supplied to the interelectrode space 112 by means of the powder supply mechanism or injector 115. Next, voltage is supplied to the metallic electrodes from the high-voltage power supply unit 108. A part of the powder particles (not shown) should already have an uncompensated charge, but neutral particles will acquire the uncompensated charge under the effect of the electric field shown by the arrow EF (although the direction of the electric field is shown toward the charging electrode 104, the potentials on the electrodes 104 and 106 can be changed by a switch SW so that the direction of the electric field will change). As a result, under the effect of the electric field EF, the charged particles begin to move with acceleration to the net-like acceleration electrode 106, and when they reach this electrode, the particles develop significant kinetic energy that depends on the value of the charge, particle mass, and potential difference between electrodes.

More specifically, the particle charge can be evaluated by the following equation:

Q=ε₀AE, (1)

where:

“Q” is a dust particle charge; ε₀ is dielectric permeability of vacuum; “A” is the surface area of the particles; and E is the intensity of the external electric field.

A charged particle experiences an effect of the electric field, and when the electric force is greater than the weight of the particle, the latter may levitate. The value of this critical electric field “E_{c}” is evaluated from balance of forces in the following manner:

mg=ε₀AE_{c}², (2)

where:

“m” is the mass of a dust particle, and “g” is acceleration of gravity. For a spherical particle, the value of the critical electric field is equal to

$${E}_{c} = \sqrt{\frac{ρ d g}{6 {ɛ}_{0}}} , \qquad ( 3 )$$

where: ρ the density of the particle material; and d is the particle diameter.

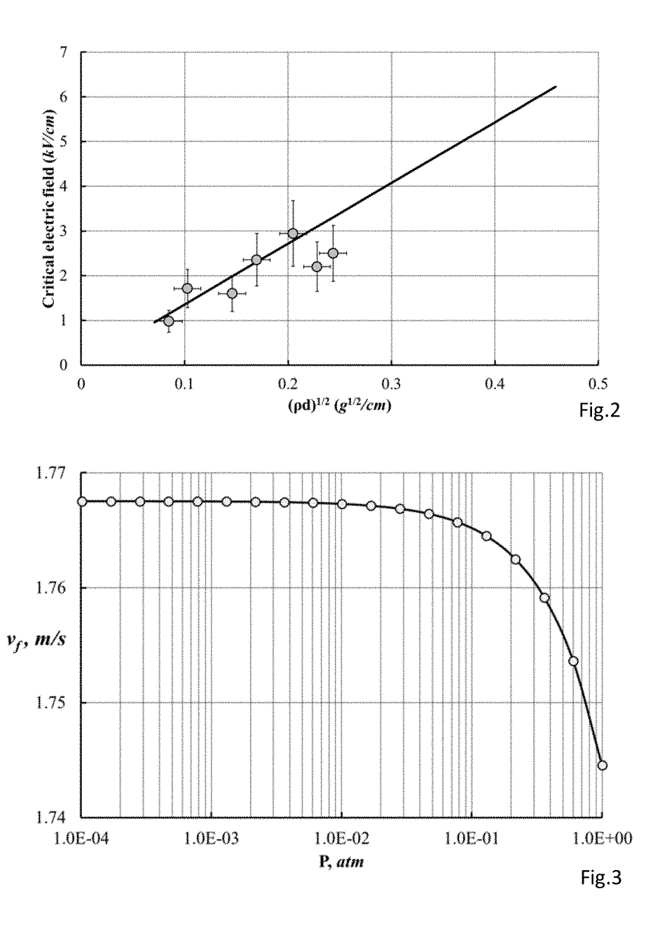

E_{c} can also be represented by the following empirical formula: E_{c}=ç13.59\sqrt{ρd}, which was based on experiments described below with reference to FIG. 2.

FIG. 2 shows theoretical and experimental values of a critical electric field for various solid materials. The values of these critical electric fields for various solid materials are shown in Table 1. Particles used in the experiments had cubical or spherical shapes, and the dimensions of cubical particles were recalculated to diameters of spherical particles of the same surface area. The data is presented in FIG. 2 and shows that the measurement data and theoretical data correspond to each other.

When the intensity of the electric field is higher than its critical value for a given particle type, particles are accelerated. If friction forces are neglected, the pulse equation can be written as follows:

$$m \frac{d υ}{dt} = {ɛ}_{0} A {E}^{2} - m g , \qquad ( 4 )$$

where: v is the velocity of a charged solid particle.

TABLE 1
Critical electric fields for various electrically
chargeable solid particles

| Material | Density | Dimension | Critical electric field |
|---|---|---|---|
| of particle | (g/cm³) | (μm) | (kV/cm) |
| Al₂O₃ | 3.2 | 100 | 1.6 |
| Cu | 8.9 | 100 | 2.2 |
| Fe | 7.8 | 100 | 2.3 |
| NaCl | 2.16 | 200 | 2.3 |
| SiO₂ | 2.65 | 300 | 2.9 |

A charged particle is accelerated by the electric field in the direction opposite to the direction of gravity force. If we assume that electric force intensity U=EI is constant throughout particle acceleration between two electrodes, accumulated kinetic energy acquired by the particle can be expressed by the following equation:

$$K ( {ɛ}_{0} A \frac{{U}^{2}}{{I}^{2}} - m g ) 1 , \qquad ( 5 )$$

where: “I” is the acceleration path, and U is the applied field intensity between electrodes.

When the particle is accelerated, the particle collides with the material of the membrane. In this case, the particle may be reflected from the surface of the membrane or may penetrate into the material, leaving a trail of the material in the form of pore, or tracks. The geometry of the pores formed corresponds to the flight path of the particle within the material. The kinetic energy of an accelerated particle is converted into energy of destruction of the material. It is assumed that the hardness of the material particles is much greater than the hardness of the membrane material, and energy is not expended on the destruction of the particles themselves. For particles with a size comparable to the thickness of the bulk material (membrane material), the material may be destroyed when the brake force of inertia is balanced with the destructive power.

The conducted experiments showed the occurrence of charge on the surface of any electrically chargeable solid particle. However, the considered theory does not clearly explain the cause of the charge, the value of its density, or the nature of its link with the material from which the particles are made. Also, this theory does not sufficiently describe the dependence of the charge on the size of the used particles. On the other hand, the fact that in an electric field a solid particle can be charged and that its movement can be accelerated is experimentally observed can be used as a basis for developing various devices and processes.

When the accelerated particle collides with the material M (FIG. 1) of the membrane, the particle may be reflected from the surface of the membrane or may penetrate into the material, leaving in the material a trail in the form of a pore, also known as a track. The geometry of the pores formed corresponds to the flight path of the particles within the material. The kinetic energy of a particle accelerated by the electric field is converted into energy of destruction of the material.

Let us assume that the hardness of the material of the particles is much greater than the hardness of the membrane material and that the energy is not expended on the destruction of the particle itself. For particles with a size comparable to the thickness of the bulk material (membrane material), the material may be destroyed when the brake force of inertia is in balance with the destructive power. Thus, the critical condition can be written as follows:

ma=Sσ, (6)

where: “a” is acceleration of a solid particle in the membrane material, and S is the cross-sectional area of the destruction. In the condition expressed by equation (6), the friction force between the solid particle and the membrane material is neglected.

If it is assumed that on the other side of the membrane (i.e., on the side opposite to the bombarded side) the velocity of the particle is equal to 0), then acceleration of the particle can be expressed as follows:

$$a = \frac{{υ}_{0}^{2}}{2 h} , \qquad ( 7 )$$

where: “v₀” is the velocity of the solid particle after acceleration in the electric field; and “h” is thickness of the membrane.

The destruction area can be expressed as follows:

S=Lh (8)

where: “L” is a total length of the destruction. For a spherical solid particle the total length of the destruction can be expressed by the following formula:

$$L = n \frac{d}{2} , \qquad ( 9 ) ,$$

where “n” is the destruction number.

According to the invention, the value of the destruction number “n” is dimensionless and can be obtained experimentally. In other words, when a solid particle that moves with high velocity passes through a thin film and makes hole in it, such a hole is normally surrounded by a number of thin cracks that extend radially outward from the periphery of the formed hole. The applicants decided to evaluate the destruction number “n” as a ratio of total length of such cracks to the radius of the hole formed in the thin-film material. Of course, the number of radial cracks may vary, depending on particle velocity, strength of film material, its thickness, etc. When velocity is very high, the opening may not have cracks at all. Normally the destruction number “n” is in the range of 3 to 6, and the final value is calculated as an average value, e.g., from 10 to 20 measurements.

By using equation (5), the upper limit of membrane thickness can be determined from the following equation:

$$h = \sqrt{\frac{( {ɛ}_{0} {A ( U / I )}^{2} - m g ) l}{σ L}} , \qquad ( 10 )$$

For spherical particles, the formula for membrane thickness can be converted into the following expression (11):

$${h}_{s} = \sqrt{\frac{π ld ( 6 {{ɛ}_{0} ( U / I )}^{2} - ρ dg )}{3 σ n}} , \qquad ( 8 )$$

Calculation by means of the upper limit of membrane thickness by using formula (10) for a spherical particle of aluminum oxide (diameter d=10⁻⁴ and density ρ=3200 kg/m³) accelerated in the electric field generated by the potential difference U=6000 V at the interelectrode distance I=0.02 m, for a strength limit of the membrane material σ=10⁶ Pa, and a destruction number n=3, gives the upper limit of the membrane thickness at which the membrane can be pierced with the formation of through-openings equal to hₛ≈10⁻⁶ m.

The method of the invention is carried out as follows.

First, a specific powder 120 of a selected material (FIG. 1), shape, and size is supplied to the interelectrode space by means of the powder supply unit or injector 110. Next, voltage CV (the values of the CV are given in the subsequent practical examples) is supplied to the metallic electrodes 104 and 106 from the high-voltage power supply unit 108. A part of the powder particles should already have an uncompensated charge, but neutral particles will acquire the uncompensated charge under the effect of the electric field EF. As a result, under the effect of the electric field EF, which is generated between electrodes 104 and 106 in the interelectrode space 112, the charged particles begin to move with acceleration to the acceleration electrode 106, and when they reach this electrode, the particles develop significant kinetic energy that depends on the value of the charge, particle mass, and potential difference between electrodes.

The above process is described below in more detail. Electrically chargeable solid particles, which in the interelectrode space 112 are loaded onto the charging electrode 104 acquire a charge which in its sign corresponds to the sign of the charging electrode.

Under the effect of the electric field, the particles start moving toward the accelerating electrode 106, which bears the charge opposite the charging electrode. 104. As a result, solid powder particles are accelerated by the electric field generated between the charging and accelerating electrodes. Without encountering obstacles in their path from the side of the net-like acceleration electrode 106, the powder particles pass through the open cells 106-1, 106-2, . . . 106-n of the net and impact the thin-film material M.

After passing through the acceleration electrode 106, a part of the electrically chargeable solid particles loses its charge and continues to move by inertia without experiencing the effect of the electric field. The part of the particles that has the same charge as the acceleration electrode 106 returns under the effect of the electric field of this electrode back to the cells of the net. In this case, the particles also lose their charge and fall onto the charging electrode 104.

In order to compensate for the loss of the particles that fly away through the net and are lost, the consumed amount of the electrically chargeable solid particles is replenished by a new portion of the electrically chargeable solid particles, which is fed through the injector 112.

When treating thin-film workpieces one by one, the apparatus 100 operates in a batch mode, and workpieces are exposed to the particulate flow intermittently.

It is understood that in size, the particles are equal to or smaller than the size of cells 106-1, 106-2, 106-3, . . . 106-n of the acceleration electrode 106 and that provision of the net with cells provides uniformity of distribution of the openings formed by passage of the solid particles through the material of the treated thin-film material.

Since in case of a continuous operation with movement of the film from the thin-film tape supply bobbin 116 to the receiving bobbin 118 the velocity of the tape is several orders lower than the velocity of the electrically chargeable solid particles, the velocity of the tape can be neglected, and the exposure time shown below in formula (12) may be applicable for both continuous and batch processes.

The exposure time T (s) is determined by the intensity

$${J}_{m} ( \frac{kg}{{m}^{2} sec} )$$

of the particle stream at the output from the interelectrode space and by the desired density of holes σ (m⁻²) in the membrane to be produced. The exposure time T (s) is calculated by means of the following formula:

$$τ = \frac{σ ρ {k}_{f} {D}^{3}}{{J}_{m}} \qquad ( 12 )$$

where: ρ is density of particle material, k_{f} is the coefficient that depends on the shape of particles, and D is the average size of the particles.

Thus, it has been shown that the method of the invention allows treating a thin-film material such as polymeric plastic film to a required state with a flow of solid, electrically chargeable particles in the electric field developed between an electrode penetrable to electrically chargeable solid particles and an electrode that is not penetrable to electrically chargeable solid particles. One of the electrodes is under the voltage of one predetermined sign and the other electrode is under a voltage having a sign opposite to the first electrode. The aforementioned other electrode may be electrically isolated from the first electrode for accelerating the movement of particles from the second electrode to the first electrode. The aforementioned required state is selected in the range from retaining the electrically chargeable solid particles in the thin-film material to the state of passing the electrically chargeable solid particles through the thin-film material, thus forming perforations in the treated thin-film material. This can be achieved by adjusting the voltage applied to the electrodes to a value needed to obtain the treated thin-film material of a required state. The pressure in the interelectrode space can be maintained below the atmospheric range and the space can be filled with an inter gas.

The treated thin-film material can be further used for manufacturing filters for fluids, tracking membranes, or the like.

The apparatus suitable for carrying out the method of the invention may comprise either a thin-film sheet or a band that can be fed from the supply bobbin to the receiving bobbin to expose the area of treatment in a fixed position over the acceleration electrode. In the subsequent practical example, the applicants refer to the use of a rectangular sample in the form of thin-film sheets replaceable for each treatment time. However, examples with sheet-like samples should not be considered as limiting the scope of the invention.

### PRACTICAL EXAMPLE 1

The sample of the polymer prepared for treatment according to the present invention was a rectangular-shaped film having a thickness of 15 microns and made from high-density polyethylene. A working substance for treating the sample comprised an aluminum oxide powder with a particle size of 100±10 microns.

The test was conducted using the apparatus of the type described above, and shown in FIG. 1, with the following interior dimensions of the working chamber: 100 mm (L)×30 mm (W)×100 mm (H). The distance between the charging electrode and acceleration electrode was equal to 80 mm. The aluminum oxide particles accelerated in air under a pressure of 0.01 atm by the acceleration electrode under the effect of the electric field generated by the potential difference between the charging and acceleration electrodes equal to 15 kV and developed a velocity of 3.8 m/s. The exposure time of the powder to the electric field was 1 min. The oxide aluminum particles that failed to pierce the sample film easily could be mechanically removed from the treated surface by water jet. The through-openings formed in the sample film had an average diameter of 50±15 μm.

### PRACTICAL EXAMPLE 2

The sample of the polymer prepared for treatment according to the present invention was a rectangular-shaped film having a thickness of 15 microns and made from high-density polyethylene. A working substance for treating the sample comprised an iron powder with a particle size of 100±10 microns. The test was conducted using the apparatus of the type described above, and shown in FIG. 1, with the following interior dimensions of the working chamber: 100 mm (L)×30 mm (W)×100 mm (H). The distance between the charging electrode and acceleration electrode was equal to 80 mm. The aluminum oxide particles accelerated in air under pressure of 0.01 atm by the acceleration electrode under the effect of the electric field generated by the potential different between the charging and acceleration electrodes equal to 15 kV and developed a velocity of 2.9 m/s. The exposure time of the powder to the electric field was 1 min. The iron particles that failed to pierce the sample film could be easily removed from the treated film by dipping them into a 5% hydrochloric acid solution. The through-openings formed in the sample film had an average diameter of 30±10 μm.

### PRACTICAL EXAMPLE 3

The sample of the polymer prepared for treatment according to the present invention was a rectangular-shaped film having a thickness of 15 microns and made from high-density polyethylene. The working substance for treating the sample comprised a copper powder with a particle size of 100±10 microns. The test was conducted using the apparatus of the type described above, and shown in FIG. 1, with the following interior dimensions of the working chamber: 100 mm (L)×30 mm (W)×100 mm (H). The distance between the charging electrode and acceleration electrode was equal to 80 mm. The aluminum oxide particles accelerated in air under pressure of 0.01 atm by the acceleration electrode under the effect of the electric field generated by the potential difference between the charging and acceleration electrodes equal to 15 kV developed a velocity of 2.7 m/s. The exposure time of the powder to the electric field was 1 min. The copper particles that failed to pierce the sample film could be easily removed from the treated film by dipping them into a 5% nitric acid solution. The through-openings formed in the sample film had an average diameter of 30±10 μm.

### PRACTICAL EXAMPLE 4

The sample of the polymer prepared for treatment according to the present invention was a rectangular-shaped film having a thickness of 15 microns and made from high-density polyethylene. The working substance for treating the sample comprised a sodium chloride powder with a particle size of 35±10 microns. The test was conducted using the apparatus of the type described above, and shown in FIG. 1, with the following interior dimensions of the working chamber: 100 mm (L)×30 mm (W)×100 mm (H). The distance between the charging electrode and acceleration electrode was equal to 80 mm. The sodium chloride particles accelerated in air under pressure of 0.01 atm by the acceleration electrode under the effect of the electric field generated by the potential different between the charging and acceleration electrodes equal to 15 kV and developed a velocity of 5.6 m/s. The exposure time of the powder to the electric field was 1 min. The copper chloride particles that failed to pierce the sample film could be easily removed from the treated film with a water jet. The through-openings formed in the sample film had an average diameter of 25±5 μm.

### PRACTICAL EXAMPLE 5

The sample of the polymer prepared for treatment according to the present invention was a rectangular-shaped film having a thickness of 15 microns and made from high-density polyethylene. The working substance for treating the sample comprised a saccharose powder with a particle size of 30±5 microns. The test was conducted using the apparatus of the type described above, and shown in FIG. 1, with the following interior dimensions of the working chamber: 100 mm (L)×30 mm (W)×100 mm (H). The distance between the charging electrode and acceleration electrode was equal to 80 mm. The saccharose particles accelerated in air under pressure of 0.01 atm by the acceleration electrode under the effect of the electric field generated by the potential difference between the charging and acceleration electrodes equal to 15 kV developed a velocity of 6.3 m/s. The exposure time of the powder to the electric field was 1 min. The saccharose particles that failed to pierce the sample film could be easily removed from the treated film with a water jet. The through-openings formed in the sample film had an average diameter of 20±5 μm.

### PRACTICAL EXAMPLE 6

The sample of the polymer prepared for treatment according to the present invention was a rectangular-shaped film having a thickness of 15 microns and made from high-density polyethylene. The working substance for treating the sample comprised a silicon oxide powder with a particle size of 12±2 microns. The test was conducted using the apparatus of the type described above, and shown in FIG. 1, with the following interior dimensions of the working chamber: 100 mm (L)×30 mm (W)×100 mm (H). The distance between the charging electrode and acceleration electrode was equal to 80 mm. The silicon oxide particles accelerated in air under pressure of 0.01 atm by the acceleration electrode under the effect of the electric field generated by the potential different between the charging and acceleration electrodes equal to 15 kV and developed a velocity of 42 m/s. The exposure time of the powder to the electric field was 1 min. The silicon oxide particles that failed to pierce the sample film could be easily removed from the treated film by immersing them into a 5% solution of sodium hydroxide. The through-openings formed in the sample film had an average diameter of 10±1 μm.

### PRACTICAL EXAMPLE 7

A sample of the polymer prepared for treatment according to the present invention was a rectangular-shaped film having a thickness of 15 microns and made from high-density polyethylene. A working substance for treating the sample comprised a sodium chloride powder with a particle size of 35±10 microns. The test was conducted using the apparatus of the type described above, and shown in FIG. 1, with the following interior dimensions of the working chamber: 100 mm (L)×30 mm (W)×100 mm (H). The distance between the charging electrode and acceleration electrode was equal to 20 mm. The sodium chloride particles accelerated in air under pressure of 0.01 atm by the acceleration electrode under the effect of the electric field generated by the potential difference between the charging and acceleration electrodes equal to 25 kV developed a velocity of 14 m/s. The exposure time of the powder to the electric field was 30 sec. The copper chloride particles that failed to pierce the sample film could be easily removed from the treated film with a water jet. The through-openings formed in the sample film had an average diameter of 22±5 μm.

### PRACTICAL EXAMPLE 8

The sample of the polymer prepared for treatment according to the present invention was a rectangular-shaped film having a thickness of 24 microns and made from high-density polyethylene. The working substance for treating the sample comprised a sodium chloride powder with a particle size of 35±5 microns. The test was conducted using the apparatus of the type described above, and shown in FIG. 1, with the following interior dimensions of the working chamber: 100 mm (L)×30 mm (W)×100 mm (H). The distance between the charging electrode and acceleration electrode was equal to 20 mm. The sodium chloride particles accelerated in air under pressure of 0.01 atm by the acceleration electrode under the effect of the electric field generated by the potential difference between the charging and acceleration electrodes equal to 30 kV and developed a velocity of 16 m/s. The exposure time of the powder to the electric field was 30 sec. The copper chloride particles that failed to pierce the sample film could be easily removed from the treated film with a water jet. The through-openings formed in the sample film had an average diameter of 20±5 μm.

### PRACTICAL EXAMPLE 9

The sample of the polymer prepared for impregnation of electrically chargeable solid particles into the structure of a material was a rectangular-shaped film having a thickness of 200 microns and made from high-density polyethylene. The working substance for treating the sample comprised an aluminum oxide powder with a particle size of 100±10 microns. The test was conducted using the apparatus of the type described above, and shown in FIG. 1, with the following interior dimensions of the working chamber: 100 mm (L)×30 mm (W)×100 mm (H). The distance between the charging electrode and acceleration electrode was equal to 20 mm. The aluminum oxide particles accelerated in air under pressure of 0.01 atm by the acceleration electrode under the effect of the electric field generated by the potential different between the charging and acceleration electrodes equal to 15 kV and developed a velocity of 7 m/s. The exposure time of the powder to the electric field was 1 min. The aluminum oxide particles penetrated into the material of the sample film and were fixed in its surface layer. Rinsing with water could not remove the particles from the surface layer. The through particles could not pierce the sample film.

### PRACTICAL EXAMPLE 10

The sample of the polymer prepared for impregnation of electrically chargeable solid particles into the structure of a material was a rectangular-shaped film having a thickness of 200 microns and made from high-density polyethylene. The working substance for treating the sample comprised an iron powder with a particle size of 100±10 microns. The test was conducted using the apparatus of the type described above, and shown in FIG. 1, with the following interior dimensions of the working chamber: 100 mm (L)×30 mm (W)×100 mm (H). The distance between the charging electrode and acceleration electrode was equal to 20 mm. The iron particles accelerated in air under pressure of 0.01 atm by the acceleration electrode under the effect of the electric field generated by the potential different between the charging and acceleration electrodes equal to 15 kV and developed a velocity of 6.5 m/s. The exposure time of the powder to the electric field was 1 min. The iron particles penetrated into the material of the sample film and were fixed in its surface layer. Rinsing with water could not remove the particles from the surface layer. The particles could not pierce the sample film.

The experiments conducted for testing the method of the invention made it possible to collect theoretical data. By using this data and the formula shown above, it was possible to make theoretical calculations and to plot theoretical and experimental curves, which are shown in FIGS. 2 to 9 and described below.

FIG. 2 is a graph that shows theoretical and experimental values of a critical electric field for various solid materials as a square root function of particle density and size. The experimental data are shown by white dots.

FIG. 3 is a graph that shows the effect of external pressure (P, atm) on the velocity of movement of aluminum oxide particles with an average size of 100 μm in the electric field generated by the 10000 V potential difference at the interelectrode distance of 10 mm, The experimental data are shown by white dots.

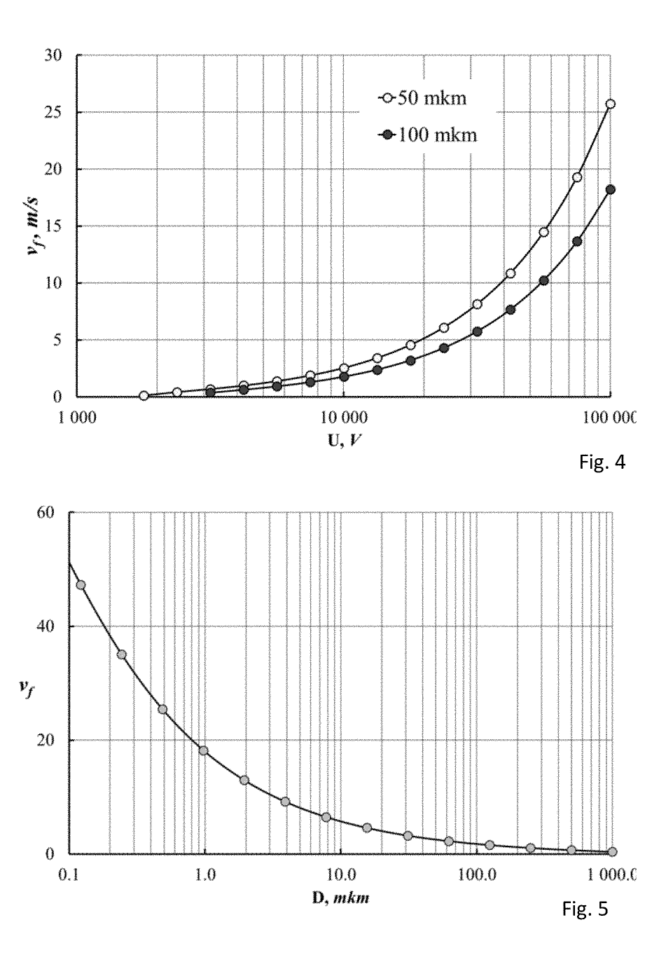

FIG. 4 is a graph that shows the effect of the potential difference on the velocity of aluminum oxide particles with an average size of 100 μm at the interelectrode distance of 10 mm and under a pressure of 0.01 atm. The experimental data are shown by white dots.

FIG. 5 is a graph that shows the effect of the aluminum oxide particle size on the velocity of its movement in an electric field generated by the 10000 V potential difference at the interelectrode distance of 10 mm and under a pressure of 0.01 atm. The experimental data are shown by white dots.

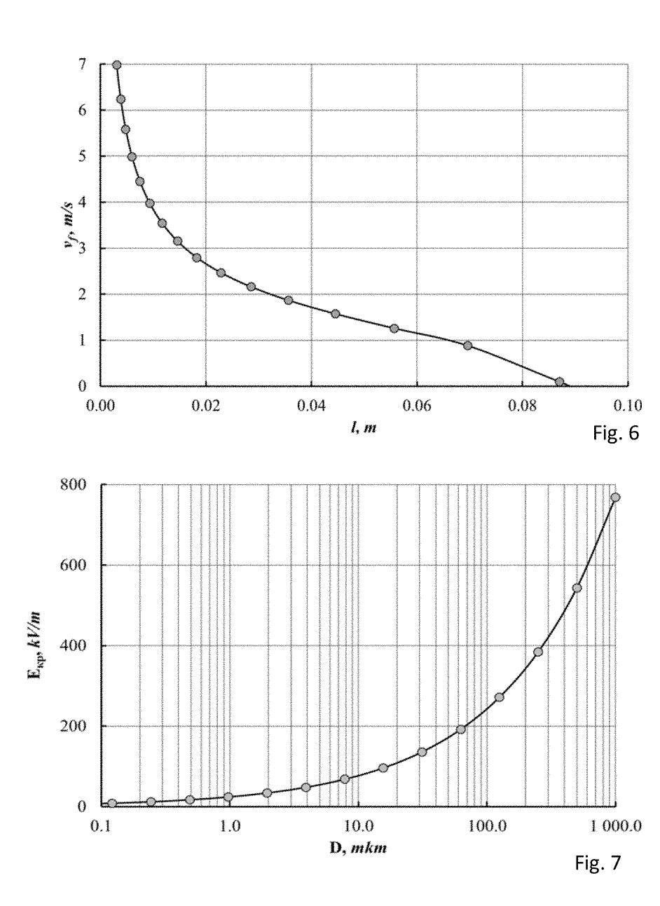

FIG. 6 is a graph that shows the effect of the interelectrode distance (I, m) on the velocity of movement of the aluminum oxide particles having an average size of 50 μm in an electric field generated by the 10000 V potential difference under a pressure of 0.01 atm. The experimental data are shown by white dots.

FIG. 7 is a graph that shows the effect of the average size of the aluminum oxide particles on the value of the critical field at the pressure 0.01 atm. The experimental data are shown by white dots.

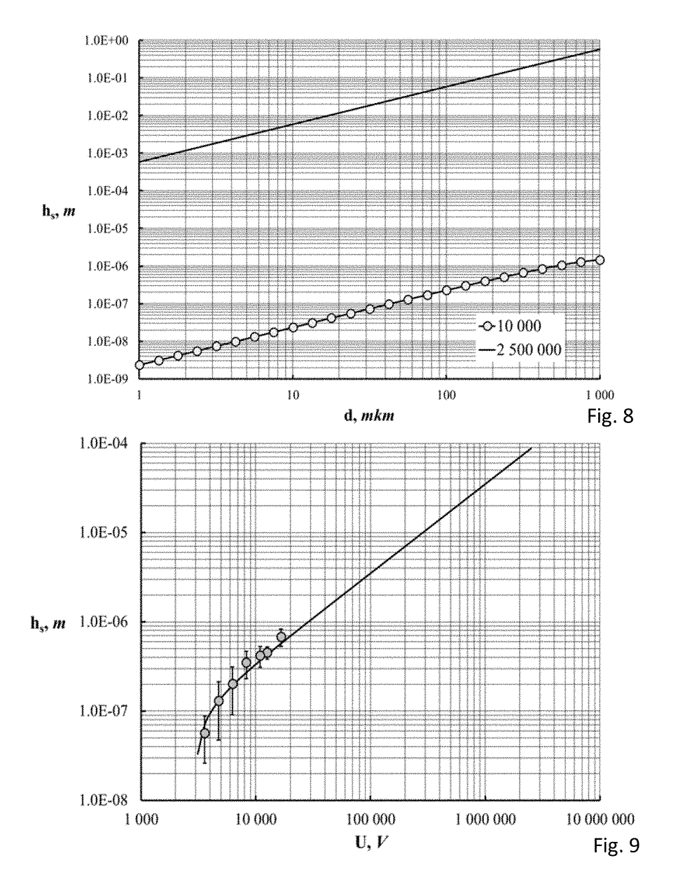

FIG. 8 is a graph that shows the effect of the average size of the aluminum oxide particles and voltage between the electrodes on the depth of penetration of the particles into the polyethylene matrix at the pressure of 0.01 atm. The experimental data are shown by white dots.

FIG. 9 shows dependence of the theoretical depth of penetration of the aluminum oxide particles with a size of 150 μm into the polyethylene matrix on the voltage between the electrodes under a pressure of 0.01 atm. The curve with round dots was plotted on the basis of experimental data.

The method and apparatus of the invention were shown and described with reference to specific processes and drawings. It is understood, however, that these processes and drawings should be construed only as examples and that any changes and modifications are possible if they do not depart from the scope of the attached claims. For example, a great variety of particles of organic and inorganic nature having a great variety of shapes and hardness can be used instead of those mentioned in the specification. The apparatus for carrying out the method, as well as its mechanisms, may be embodied in a manner different from the one shown in FIG. 1. For example, the number of openings in the acceleration electrode may vary from 1 to “n”. This means that the acceleration electrode may comprise a metal loop. The method and apparatus of the invention are applicable not only for manufacturing of a track membrane for use as a filter for hemodialysis or for filtration of gases and liquids, but also for imparting new properties to the material of the treated films. For example, by bombarding the matrix material with particles of soluble salts with subsequent dissolving of the particles stuck in the material, it is possible make the material porous, or by filling the material with electroconductive particles, it is possible make the material electroconductive. By treating the surface of the matrix material with some other particles, it is possible to impart to the surface hydrophobic or hydrophilic properties, or the like.

1.-17. (canceled)

18. A method for treating a thin-film material to a required state with a flow of solid and electrically chargeable particles in an electric field comprising the steps of:
providing a first electrode penetrable to electrically chargeable solid particles and a second electrode which is not penetrable to electrically chargeable solid particles;
arranging both electrodes at a distance from each other, thus forming an interelectrode space;
providing a voltage source and applying a voltage of a predetermined sign to one of said electrodes and a voltage of an opposite sign to another of said electrodes, thus generating an electric field in the interelectrode space;
placing a thin-film material to be treated above the first electrode;
feeding electrically chargeable solid particles into the interelectrode space onto or near the second electrode;
charging the electrically chargeable solid particles with the charge of the same sign as the second electrode; and
generating a flow of electrically chargeable solid particles from the second electrode to the first electrode and through the first electrode to the thin-film material, thus treating the thin-film material to a required state with the electrically chargeable solid particles and obtaining a treated thin-film material.

19. The method according to claim 18, wherein the thin-film material has a predetermined thickness and the voltage source is adjustable, the method further comprising the step of adjusting the voltage to a value needed to obtain the treated thin-film material of a required state.

20. The method according to claim 19, wherein said required state is selected in the range from retaining the electrically chargeable solid particles in the thin-film material to the state of passing the electrically chargeable solid particles through the thin-film material, thus forming perforations in the treated thin-film material.

21. The method according to claim 20, comprising the step of generating in the interelectrode space a pressure below atmospheric pressure.

22. The method according to claim 21, comprising the step of filling the interelectrode space with an inert gas.

23. The method according to claim 22, wherein the electrically chargeable solid particles are selected from the group consisting of particles made from an organic substance and particles made from an inorganic substance.

24. The method according to claim 23, wherein the treated thin-film material is used for manufacturing filters for fluids.

25. The method according to claim 23, wherein the treated thin-film material is used for manufacturing track membranes.

26. The method according to claim 18, wherein the thin-film material is a polymeric plastic film.

27. The method according to claim 18, wherein the electrode penetrable to electrically chargeable solid particles is a net with net cells that pass electrically chargeable solid particles.

28. The method according to claim 23, wherein the electrode penetrable to chargeable solid particles is a net with net cells that pass electrically chargeable solid particles.

29. The method according to claim 18, wherein the electrode which is not penetrable to electrically chargeable solid particles is electrically isolated from the electrically chargeable solid particles for accelerating their movement toward the electrode which is penetrable to electrically chargeable solid particles.

30. The method according to claim 18, wherein the electrode which is not penetrable to electrically chargeable solid particles is electrically isolated from the electrically chargeable solid particles for accelerating their movement toward the electrode which is penetrable to electrically chargeable solid particles.

31. The method according to claim 24, wherein the electrode which is not penetrable to electrically chargeable solid particles is electrically isolated from the electrically chargeable solid particles for accelerating their movement toward the electrode which is penetrable to electrically chargeable solid particles.

32. The method according to claim 25, wherein the electrode which is not penetrable to electrically chargeable solid particles is electrically isolated from the electrically chargeable solid particles for accelerating their movement toward the electrode which is penetrable to electrically chargeable solid particles.

33. The method according to claim 18, wherein the electric field generated in the interelectrode space has a critical value E_{c} at which the electrically chargeable solid particles start moving from the electrode which is not penetrable to the electrically chargeable particles toward the electrode which is penetrable to electrically chargeable particles, wherein E_{c} is represented by the following formula:
E_{c}=13.59\sqrt{ρd},
where ρ is the density of the material of the electrically chargeable particles and d is the size of the electrically chargeable particles.

34. The method according to claim 23, wherein the electric field generated in the interelectrode space has a critical value E_{c} at which the electrically chargeable solid particles start moving from the electrode which is not penetrable to the electrically chargeable particles toward the electrode which is penetrable to electrically chargeable particles, wherein E_{c} is represented by the following formula:
E_{c}=13.59\sqrt{ρd},
where ρ is the density of the material of the electrically chargeable particles and d is the size of the electrically chargeable particles.

35. The method according to claim 24, wherein the electric field generated in the interelectrode space has a critical value E_{c} at which the electrically chargeable solid particles start moving from the electrode which is not penetrable to electrically chargeable particles toward the electrode which is penetrable to electrically chargeable particles, wherein E_{c} is represented by the following formula:
E_{c}=13.59\sqrt{ρd},
where ρ is the density of the material of the electrically chargeable particles and d is the size of the electrically chargeable particles.

36. The method according to claim 20, wherein the first electrode is used as a particle acceleration electrode and the second electrode is used as a charging electrode.

37. The method according to claim 35, wherein the first electrode is used as a particle acceleration electrode and the second electrode is used as a charging electrode.
